(19) United States
(12) Patent Application Publication
(10) Pub. No.: US 2013/0006811 A1
(43) Pub. Date: Jan. 3, 2013

(54) ONLINE FUNDS TRANSFER METHOD

(75) Inventors: John Joseph Mascavage, III, San Mateo, CA (US); Margaret Morgan Weichert, San Carlos, CA (US); Mark Thompson, Denver, CO (US)

(73) Assignee: The Western Union Company, Englewood, CO (US)

(21) Appl. No.: 13/609,741

(22) Filed: Sep. 11, 2012

Related U.S. Application Data
(63) Continuation of application No. 10/298,152, filed on Nov. 14, 2002.
Application No. 10/298,152 is a continuation-in-part of application No. 09/991,497, filed on Nov. 15, 2001.
Application No. 09/991,497 is a continuation of application No. 09/516,209, filed on Feb. 29, 2000, now Pat. No. 7,366,695.

(51) Int. Cl. G06Q 30/06; G06Q 40/02

(52) U.S. Cl. 705/26.41; 705/42

(57) ABSTRACT

A method is provided for transferring funds related to a checkout process for a transaction initiated between a user and a merchant. The method may include storing information on a plurality of asset accounts associated with the user and receiving selection of a first account from the plurality of asset accounts as possible choices. The method may also include receiving authorization via the interface from the user to pay the merchant from the first account. The method may further include providing a digital IOU to the merchant and receiving a redemption request of the digital IOU. The method may additionally include determining, automatically with a funds transfer server, a second account associated with the merchant, and initiating, automatically with the funds transfer server in response to the redemption request, an electronic transfer between the first account and the second account that is related to the checkout process for the transaction.

This application is a continuation of U.S. patent application Ser. No. 10/298,152 filed on Nov. 14, 2002, entitled “ONLINE FUNDS TRANSFER METHOD,” which is a continuation-in-part of U.S. patent application Ser. No. 09/991,497 filed on Nov. 15, 2001, entitled “ONLINE FUNDS TRANSFER METHOD,” which is a continuation of U.S. patent application Ser. No. 09/516,209 filed Feb. 29, 2000, entitled “ELECTRONIC PURCHASE METHOD AND FUNDS TRANSFER SYSTEM,” now U.S. Pat. No. 7,366,695, all of which are all incorporated by reference, as if fully set forth herein, for any and all purposes.

### BACKGROUND OF THE INVENTION

The present invention relates to funds transfers. Particularly, the present invention is directed to online funds transfers.

The development of the Internet has created vast new markets and marketplaces. A consumer with an Internet connection may search for, and likely find, a wide variety of goods and services. While e-commerce flourishes, though, consumers are becoming more and more wary of the apparent free flow of sensitive personal, financial and other information that takes place over the Internet, especially incident to electronic purchasing. This concern is exacerbated by the limited amount of payment options available for electronic purchasing.

Consumer Internet payments, currently estimated well into the billions of dollars, are dominated by credit cards. Online credit card acceptance is a lucrative business for banks and other payment enablers, who typically charge merchants a “discount rate” of between 2-5% of the value of each transaction, in addition to a variety of other fees. Discount fees paid by online merchants are a significant source of business to credit card companies, and that business will continue to grow at an ever faster rate as online commerce continues to explode.

Although widespread, credit cards have significant limitations for merchants, consumers and small businesses. Merchant discount rates on the Internet are typically far higher than in the physical world. Moreover, those discount rates continue to rise. Further, credit card usage exposes online merchants to high fraud costs and “chargeback fees” unique to online transactions where the customer does not sign a receipt.

The dominance of credit cards also shrinks the market for online merchants and consumers. As the online population becomes more mainstream, millions of adults and teenagers without credit cards are left out of online shopping. In addition, most small business employees do not have small business credit cards. Further, credit cards are also inconvenient or illegal for some businesses. For example, legal and regulatory restrictions prevent insurance brokers, mortgage brokers and money managers from accepting many types of payments via credit cards.

Furthermore, despite the dominance of credit cards on the Internet, in the overall economy, physical paper checks are still an attractive way for most people to pay for point-of-sale purchases; this attraction is particularly pronounced among certain populations of consumers (e.g. adults over 50) and in certain merchant categories (e.g. grocery stores).

Internet auctions, a particularly fast-growing segment of the Internet commerce community, are ill-adapted for credit card purchasing. Some transactions initiated through an auction site are paid for via a personal check or money order. Each of these methods has major limitations and causes friction for consumers: personal checks sent through the mail are slow, do not come with a guarantee, and provide bank account information to an unknown person. By contrast, money orders, while providing a payment guarantee for sellers, are inconvenient for buyers who must buy them in the physical world and pay a fee for them.

The challenges and limitations of existing Internet payment methods have led to a variety of systems and methods with a host of different solutions. These systems, however, have focused on solving either the Internet payment challenges of merchants or the payment challenges of consumers. To date, there is no system or method for making an electronic purchase that overcomes the significant obstacles of the credit card and provides a useful alternative to both merchants and consumers.

One popular system that avoids some of the problems associated with the credit card is use of a debit card. Despite increased adoption and usage of debit card payments in the physical world, however, debit cards have not been particularly successful on the Internet for a variety of reasons. The debit cards that are being used on the Internet are “offline” debit cards. “Offline” debit cards work like credit cards, without the use of a personal identification number (PIN). Unlike debit transactions using a PIN, these transactions are processed through the credit card networks, resulting in a “delayed debit,” where payment is deducted 2-3 days after the transaction occurs. The “delayed debit” feature exposes banks to credit risk, and as a result, “offline” debit cards are usually only issued to individuals who already have credit cards, leaving millions of consumers without a debit vehicle for purchasing online. In addition, merchants have to pay a discount rate that is almost as high as credit card rates. Debit cards also are problematic for consumers, because many debit cards have daily volume limits that make them impractical for transactions over a particular amount. Finally, debit cards are not generally suitable for business to business transactions.

Since “online” or PIN-based debit has become so popular in the physical world, several initiatives are underway to bring PIN-based debit to the Internet. Today it is not possible to use a basic ATM card number in order to pay on the Internet. First, the information needed to process ATM card transactions, including the necessary routing information, are contained in a magnetic strip on the card. Second, a consumer's PIN requires both consumers and merchants to have access to PIN-pad technology. Existing technology does not allow for magnetic strip and PIN dependent transactions to be conducted on line. Moreover, such a system would require transmission of a consumer's closely guarded PIN over the Internet.

Other methods for electronic purchasing which have been developed by banks or check verification companies, fall into two primary categories: 1) smart-card based solutions and 2) check printing solutions. The smart card solutions are highly secure, but cumbersome, requiring consumers to have a smart card reader and smart card to pass a digital signature along with checking account information. The check printing solutions are easy for consumers, but far less secure, and require merchants to buy special check printing equipment and proprietary checks to print out (and then deposit) physical paper facsimiles of the consumer check.

Other methods for facilitating electronic payment without the use of credit cards have relied on transferring funds from a purchaser's bank account to a merchant. The prior systems and methods, however, have been unsatisfactory for a number of reasons. Most require the purchaser to communicate his or her personal financial information (including banks and account numbers) directly to the merchant each time a purchase is made, who then requests payment from a check processor. The check processor then handles the transfer of funds by creating a physical, printed check drawn on the purchaser's account, or electronically transferring funds to the merchant. Other electronic funds transfer methods require e-mail notifications to the funds recipient for every transaction. Such methods are not suitable for consumer-to-business or business-to-business use, which may include hundreds or thousands of transactions each day.

Other methods require each user to have a separate account that deals specifically with a “quasi-currency”, such as credits, discounts, mileage or unique “dollars” specific to the service provider, that must be converted to regular funds for each transaction. Others still require a user to own a credit card to be eligible for the service, even if funds are transferred from a separate bank account.

### BRIEF DESCRIPTION OF THE DRAWINGS

The present invention is described in conjunction with the appended figures:

FIG. 1A is a block diagram of an embodiment of an online transfer system;

FIG. 1B is a block diagram of another embodiment of the online transfer system;

FIG. 1C is a block diagram of yet another embodiment of the online transfer system;

FIG. 2 is a block diagram of an embodiment of a merchant system;

FIG. 3A is a block diagram of an embodiment of a funds transfer server;

FIG. 3B is a block diagram of another embodiment of the funds transfer server;

FIG. 4 is a screen shot of an embodiment of a checkout window overlaying a merchant window;

FIG. 5A is a screen shot of an embodiment of an electronic check confirmation window overlying the merchant window;

FIG. 5B is a screen shot of an embodiment of a card confirmation window overlying the merchant window;

FIG. 6 is a flow diagram of an embodiment of a process for authorizing a payment from a perspective of a customer;

FIG. 7 is a flow diagram of an embodiment of a process for authorizing and clearing the payment from a perspective of the merchant;

FIG. 8 is a flow diagram of an embodiment of the process for authorizing the payment from a perspective of a funds transfer server;

FIG. 9A is a flow diagram of an embodiment of a process for clearing the payment where the funds transfer server pays the merchant before the transfer clears;

FIG. 9B is a flow diagram of another embodiment of a process for clearing the payment where the funds transfer server transfers bank debits directly to the merchant;

FIG. 10 is a flow diagram of an embodiment of a process for creating a user account with the funds transfer server;

FIG. 11 is a flow diagram of an embodiment of a process for authenticating a user;

FIG. 12 is a flow diagram of an embodiment of a process for updating settlement with merchants; and

FIG. 13 is a flow diagram of an embodiment of a process for performing an automated clearinghouse (ACH) transfer.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE PREFERRED EMBODIMENT

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the spirit and scope of the invention as set forth in the appended claims.

In one embodiment, the present invention provides a method for transferring funds related to a checkout process for a transaction initiated online between a user and a merchant. In one step, a first bank account associated with the user is determined. Authorization is received from the user over a wide area network to pay the merchant from the first bank account. A second bank account associated with the merchant is determined. An electronic transfer is initiated between the first account and a second account that is related to the checkout process for the transaction.

In another embodiment, the present invention provides an online-accessible system for transferring funds in a checkout process for a transaction between a user and a merchant. The system includes a first interface, a second interface, a merchant web site, and a funds transfer server. The first interface is associated with a first bank account of the user, and a second interface is associated with a second bank account of the merchant. The merchant web site benefits from the checkout process. The funds transfer server initiates an electronic transfer between the first bank account and the second bank account in relation to the checkout process. An intermediate account between the first and second bank accounts is avoided in the electronic transfer.

In yet another embodiment, the present invention provides a method for transferring funds in an online transaction between a first party and a second party. Information on a plurality of accounts associated with the first party is stored. Selection of a first bank account from the plurality of accounts as possible choices is received. A second bank account associated with the second party is determined. Authorization from the first party is received over a wide area network to pay the second party from the first bank account. An electronic transfer between the first bank account and the second bank account related to the online transaction is initiated.

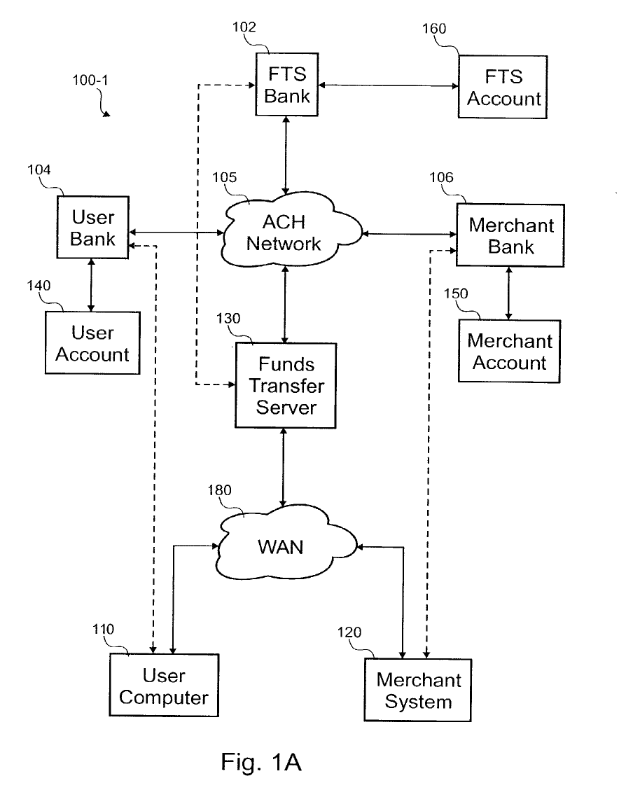

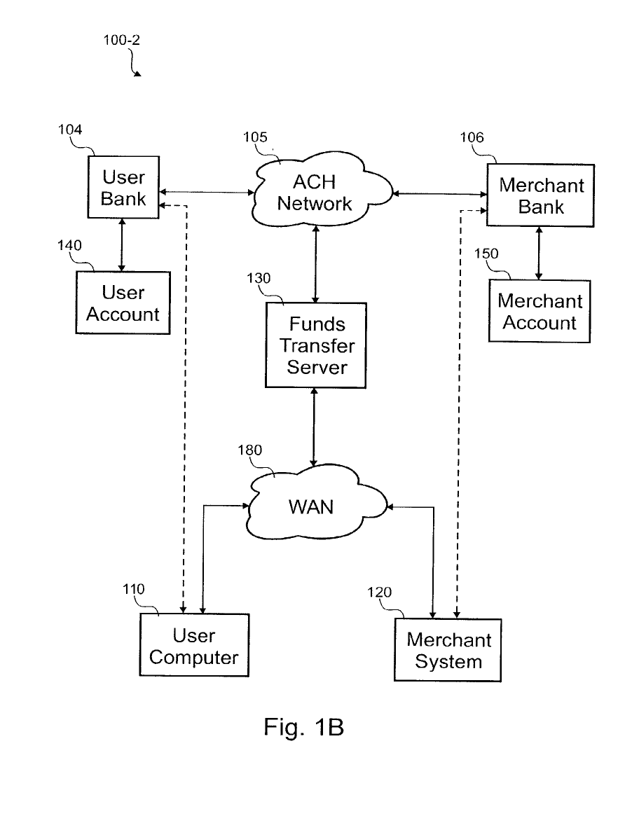

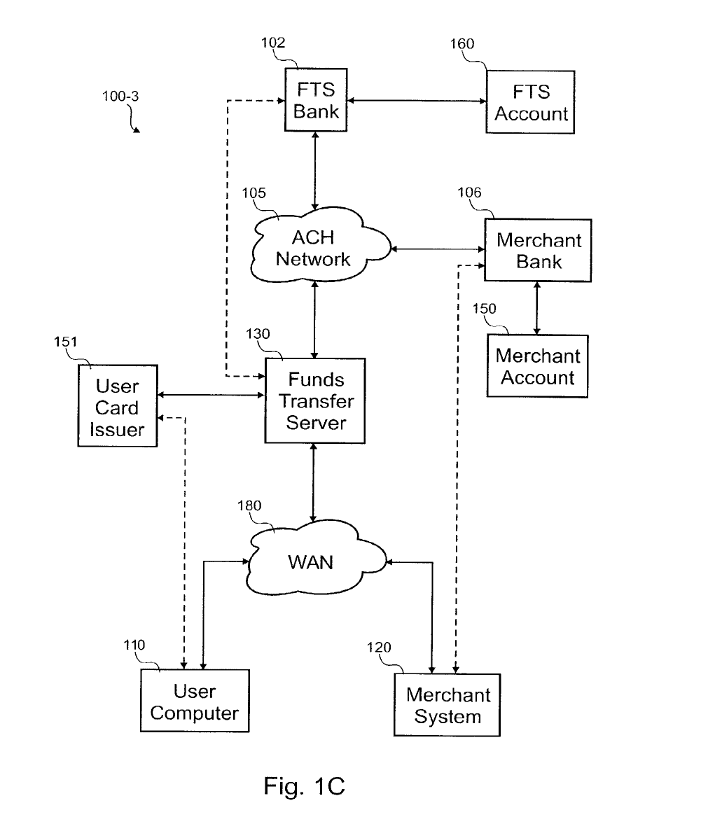

With reference to FIG. 1A, a block diagram of an embodiment of an online transfer system 100-1 is shown. This embodiment shows three banks 102, 104, 106 coupled to an ACH network 105. A funds transfer server (FTS) bank 102 has a corresponding FTS account 160, a user bank 104 has a corresponding user account 140 and a merchant bank 106 has a corresponding merchant account 150, where the three accounts 140, 150, 160 are bank accounts in this embodiment. In addition to bank accounts 140, 150, 160, other embodiments could transfer funds between credit cards, debit cards, promotional programs, check printers, agent locations that accept funds, stored value accounts, etc. In some circumstances, two or more of the FTS, user and merchant banks 102, 104, 106 could be the same bank.

A user computer 110 runs a web browser application to interact with a merchant system 120 and a funds transfer server 130. Communication between the web browser, the merchant system 120 and the FTS 130 is over a wide area network (WAN) 180 in this embodiment. Other embodiments could use any network, such as the Internet, instead of a WAN 180. As those skilled in the art can appreciate, the funds transfer server 130 could be a single computer or many computers that are connected by a network to perform as one.

Some embodiments could use custom application software to interface with the merchant system 120 and FTS 130 instead of a web browser.

On behalf of the user and the merchant, the funds transfer server 130 choreographs funds transfers between the user and FTS accounts 140, 160 and between the FTS and merchant accounts 160, 150 during a purchase. Once a payment is authorized, a digital IOU is issued to the merchant system 120 by the FTS 130. Upon completion of the purchase, typically after delivery, the merchant system 120 requests payment for the digital IOU from the FTS 130. Using the automated clearinghouse (ACH) network 105, the FTS 130 initiates a first electronic funds transfer (EFT) between the user account 140 and the FTS account 160 and a second EFT between the FTS account 160 and the merchant account 150. EFT requests can take a few days before the funds clear the target bank account. In some circumstances there may be float or reverse float that is either absorbed by the FTS 130 or passed to the user and/or merchant as a service fee. Although this embodiment performs two EFT transfers to send money from the customer to the merchant, other embodiments could send money directly from the user account 140 to the merchant account 150.

The roles of user and merchant are interchangeable. In a user and merchant for a first transaction could have the opposite roles in a second transaction. Any account holder with the FTS 130 can be both sender and receiver of funds in various transactions. In other embodiments, these roles of account holders may not be interchangeable such that a sender of funds cannot also receive funds or that a receiver of funds cannot also send funds. Some embodiments may allow both accounts that be both sender and receiver and accounts that are limited to one of those roles.

Referring next to FIG. 1B, a block diagram of another embodiment of the online transfer system 100-2 is shown. This embodiment transfers money from the user account 140 to the merchant account 150 without using the intermediary FTS account 160. The user and merchant are provided status on the transaction through the funds transfer server 130 and/or status messages. The bank account information could be shielded from the parties to the transfer. For example, the merchant bank 106 could identify the transfer on the bank statement for the merchant account using a string of characters provided from the ACH network 105 that was formulated by the funds transfer server 130 without including information for the user account 140. Similarly, the user bank could use the same or a different string of characters from the ACH network 105 to identify the transfer on any statements. The respective string of characters could have the counterparty's name and a transaction identifier or invoice number, for example.

With reference to FIG. 1C, a block diagram of yet another embodiment of the online transfer system 100-3 is shown. In this embodiment, the customer funds the transfer to the merchant account 150 from a credit card. By the funds transfer server 130 interacting with the user card issuer 151, the credit card of the user is charged upon redemption of the digital IOU by the merchant. The proceeds from that charge are stored in the FTS account 160. The merchant account 150 receives an EFT transfer from the FTS account 160 after the charge is approved by the user card issuer 151. Fees may be deducted from this transfer. In some cases, any chargebacks from the user card issuer 151 are paid by the merchant, while in other cases, those chargebacks are paid by the funds transfer server 130.

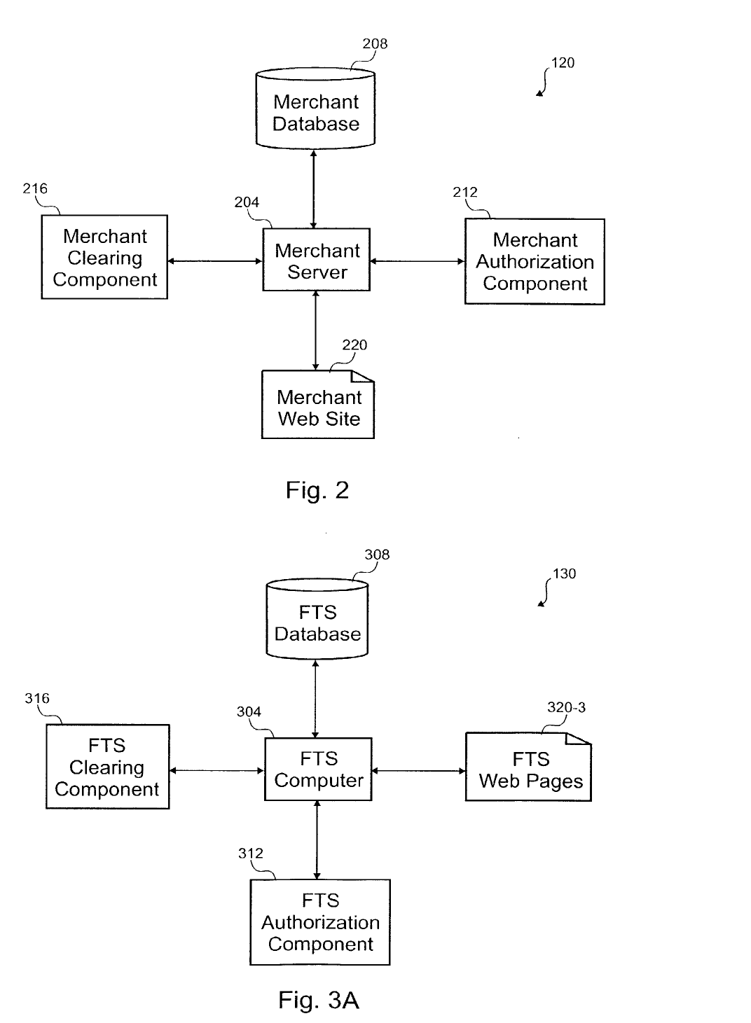

Referring next to FIG. 2, a block diagram of an embodiment of the merchant system 120 is shown. A merchant server 204, which could include one or more computers, manages operation of the merchant system 120. A merchant web site 220 runs on the merchant server 204. Users interact with the merchant web site 220 to select goods and/or services for purchase. Those skilled in the art appreciate that the merchant server 204 could be one or more computers located in one or more locations where those computers are interconnected by some sort of network. Also, some blocks of the diagram could be combined into one as those skilled in the art appreciate. Further, other components of these and other blocks diagrams described in this specification could be so divided or combined.

The merchant web site 220 interfaces with a merchant authorization component 212 and a merchant clearing component 216 to integrate the functionality of the merchant system 120 with the FTS 130. The merchant authorization component 212 communicates with the FTS 130 using the proper format, protocol, encryption and digital signatures during the authentication process where a user performs authorizes payment by the FTS 130. Communication during the clearing process is facilitated by the merchant clearing component 216 in a similar way. More specifically, the merchant clearing component 216 transports clearing files to the FTS 130 and receives settlement files from the FTS 130.

Depending upon a business model of the merchant, various information is stored in a merchant database 208. In this embodiment, digital IOUs, shipping addresses, user names, user passwords, past invoices, shipping status, and payment status is stored in the database 208. The payment status information may include where in the settlement process is a particular payment. For example, the payment status may indicate that a digital IOU was issued two days ago, a clearing file was submitted yesterday that presented a certain portion of the digital IOU and a settlement file today indicated the EFT had cleared that portion. In some circumstances, the merchant may wait for the EFT funds to clear before sending the goods and/or providing service to the user.

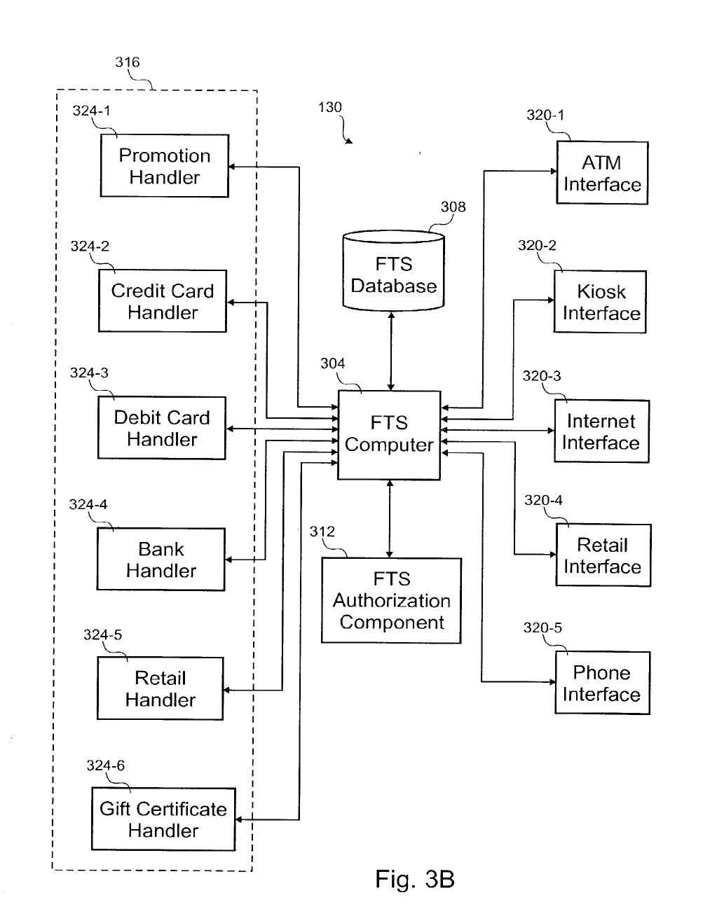

With reference to FIG. 3A, a block diagram of an embodiment of a funds transfer server 130 is shown. In this embodiment, the funds transfer server 130 interacts with many users, merchants, payees, payors, and others that send money to authorize and clear those transfers while minimizing the transfer of private information between the parties of the transfer in this embodiment. Included in the FTS 130 are a FTS computer 304 that hosts a FTS clearing component 316, a FTS authorization component 312, FTS web pages 320-3, and a FTS database 308. Those skilled in the art appreciate that the FTS computer 304 could be one or more computers located in one or more locations where those computers are interconnected by some sort of network. Also, some blocks of the diagram could be combined into one as those skilled in the art appreciate. Further, other components of these and other blocks diagrams described in this specification could be so divided or combined.

Interaction with the FTS 130 is typically encrypted to protect privacy and digital signatures are used to verify identity. In one embodiment, 128-bit secure sockets layer (SSL) encryption is used along with digital signatures that use asymmetric keys. Those skilled in the art appreciate that any mechanisms for protecting the interaction from interception and verifying the parties could be used.

The FTS authorization component 312 interacts with the merchant and user to verify their identities and authorize the money transfer. Specifics of the transaction are gathered by the FTS authorization component 312 from the merchant authorization component 212. Those specifics are presented to the user through interaction with FTS web pages 320-3. The user can specify the source of the funds and authorize the transfer. That authorization is recorded for the user in the FTS database 308 along with a digital IOU for the merchant. The FTS authorization component 312 notifies the merchant authorization component 212 of the digital IOU.

Codes are passed back and forth during the authorization and digital IOU generation process. For example, an authentication code could be given to the merchant authorization component 212 from the FTS 130 when the user successfully authenticates themselves to the FTS 130. After the user approves payment and/or the payment is initially approved by a handler, a second code is passed to the merchant system 120 to serve as the digital IOU. Presentment of both of these codes later is indicia that the user was authenticated and the purchase was authorized. These codes could be randomly generated or be algorithmically related to other information. For example, the authentication code could be a hash of a combination of the user's login information and the merchant identifier. The FTS 130 could verify the authentication code when it is later received from the merchant by storing a copy or regenerating the code. In this embodiment, encryption techniques prevent forged creation of the authentication and digital IOU codes such that only the FTS 130 can create valid codes.

Once the authentication code and digital IOU are issued to the merchant (or payor, in some embodiments), the merchant system 120 interacts with the FTS clearing component 180 to complete the money transfer. Once the item is delivered, the service performed or other condition of the transfer is performed, the digital IOU is redeemed by adding an entry to a clearing file that is sent by the merchant clearing component 716 to the FTS clearing component 312. In this embodiment, the entry has the authentication code, the digital IOU and an amount being presented for payment.

The information in the clearing file is stored in the FTS database 308. Once one or more entries are received by the FTS 130 in the clearing file, those transfers are formulated and requested by the FTS clearing component 316 from the ACH network 105. Any response from the ACH network 105 is recorded in the FTS database 308. The merchant clearing component 216 can receive status on all transfers to that merchant 120 by requesting a settlement file that includes current status on each transaction from the FTS database 308. Some embodiments of the FTS 130 could periodically send settlement files without prompting. The settlement file could have only the transactions that had a status change or the status of all recent transactions.

The FTS web pages 320 serve as the interface to the FTS 130. In addition to facilitating the authorization process with web pages, anyone with an account at the FTS 130 can use the FTS web pages 320 to view their payments and/or receipts. The status of each transaction is also shown using a checkbook register-like paradigm. The account holders can specify the source of funds for transactions. Where there are more than one source specified, a default one is specified that can be overridden during the authorization process. For those that receive money using the FTS 130, acceptable payment types can be specified. For example, a merchant may specify that VISA™ and stored value funds are the only payment sources that are accepted. During the authorization process, the payment options presented to the user are reduced by those accepted by the merchant.

E-mail, WAP, instant messaging, pager, and other messaging mechanisms are used to notify the user and/or merchant of status related to payments. The amount of status messages is customizable by the parties. For example, a large merchant may not want any messages except when a transfer is rejected, but a user may want to know when charges are authorized and digital IOUs are redeemed.

With reference to FIG. 3B, a block diagram of another embodiment of a funds transfer server 130 is shown. In this embodiment, six handlers 324 are shown that form the FTS clearing component 316. Five user interfaces 320 are also shown that allow alternative or complementary access to the FTS computer 304. Other embodiments could have more or less handlers 324 and interfaces 320. Each of the handlers 324 allows a user or merchant to add and/or remove money from the funds transfer server 130 and configure payments and transfers. Normally, the user can choose the handler 324 to use for a transfer, but in some circumstances, the merchant can choose the handler 324 or at least eliminate some possible handlers 324. For example, the merchant may specify use of credit cards or gift certificates as the only choice for payments from which the user can choose when configuring a transfer. The user interfaces 320 allow interaction with the funds transfer system 130.

The promotion handler 324-1 allows funding a transfer from promotional coupons or program points from an affinity program. Examples include airline mileage programs, prepaid phone cards, coupons, discount certificates, etc. For example, a user could use airline miles with an airline mileage handler 324-1 to fund purchase of merchandise. A conversion rate would be applied to convert the mileage credit to a monetary amount. The promotion handler 324-1 may need special information from the funds transfer server 130, such as the user's 110 promotion account number, etc. Some of the interfaces 320 used to gain access to the FTS 130 could be used to also gain access to the merchant web site 220 to allow ordering goods a user computer 110 may not be readily available to the user.

The credit and debit card handlers 324-2, 324-3 largely behave the same from the perspective of the user. Both can be used to add money into the FTS 130 or fund a transfer. In other embodiments, these handlers 324-2, 324-3 can also be used to remove money from the FTS 130 also, for example, to purchase a prepaid credit/debit card, to pay down a balance on a credit card, or to add credit to a bank account associated with a debit card. To use these handlers 324-2, 324-3, the FTS 130 stores the information for interacting with credit or debit cards in the conventional way, such as the account number, expiration date, name, and/or PIN. Similar information may be used when paying-out money to a credit/debit card.

The bank handler 324-4 allows electronic funds transfer (EFT) of money to or from a bank account of the user using the ACH network 105. The user enters the account number and routing information into the FTS 130 with a user interface 320 to facilitate adding and removing of money from the FTS 130 or to transfer money with this handler 324-4. In one embodiment, an automated teller machine (ATM) could incorporate the bank handler 324-4 along with an ATM interface 320-1 to allow performing transfers along with interfacing with the FTS 130. Another embodiment uses a bank handler 324-4 branch location as a retail interface 320-4 for interacting with the FTS 130. Some embodiments could wire money into or out of a bank account of the user instead of an EFT.

As briefly discussed above, the ATM interface 320-1 allows interaction with the FTS 130. The user or merchant may or may not have an affiliation with the ATM that is used to interface with the FTS 130. Where there is no affiliation, the owner of the ATM may charge the user a fee for this service. The user or merchant could receive cash or deposit cash if the ATM is coupled to a bank handler 324-4 or some other handler 324. In any event, the ATM interface 320-1 can be used to interface with the FTS 130 in the same way as one could interact through a web browser and computer with the FTS 130. If the ATM has a magnetic stripe or smart card reader, this could be used by to avoid entering credit or debit card information manually for the FTS 130.

The retail handler 324-5 typically corresponds to a retail location that may wire money, print money orders and/or cash checks. Money may be sent to the retail handler 324-5, whereafter the merchant is issued cash or a negotiable instrument for that money. Money can be added to or removed from a stored value account of the FTS 130 by the retail handler 324-5 also, which can be used for funding a transfer. For example, the user may give cash to the agent at a retail location who enters a credit into the FTS 130. The user could further specify to the agent a merchant who should receive the money. A retail interface 320-4 at the retail location is used by the agent to indicate to the FTS 130 that the money has been received from or by the user. Through a retail handler 324-5, a user or merchant could use the online transfer system 100 without any knowledge of computers or without any debit/credit card or bank account.

Gift certificates are dispensed or redeemed through one or more gift certificate handlers 324-6. The gift certificate can be limited to merchandise and/or services from a single store or a group of stores. In some cases, the gift certificate is used only online by entering a code provided to the receiver or could be printed for use in a bricks and mortar store. The code would be entered into the FTS 130 who would redeem it with the gift certificate handler 324-6 before applying credit to the merchant. Cash equivalents such as Flooz™, formerly available from Flooz.com, could also be provided to the FTS 130 for credit to the merchant for the items purchased by the user.

A kiosk interface 320-2 allows a user to interact with the FTS 130, but typically does not allow adding or removing cash. The kiosk interface 320-2 may be a browser terminal available for general use. Some embodiments may include a check or money order printer for removing money from the system 100. Other embodiments could include a cash intake mechanism for accepting bills and coins from the user. The kiosk interface 320-2 could be in a retail location and linked to the other systems in the retail location such that a payout or other services could be provided by other systems in the retail location.

An Internet interface 320-3 is typically accessed with a web browser. The browser downloads and renders web pages formulated by the FTS 130. The Internet interface could be hosted by the computer 110 of the user in some embodiments. Some embodiments could host the Internet interface on a portable device such as a wireless phone or personal digital assistant (PDA). The Internet interface 320-3 may also be used by the ATM, kiosk and retail interfaces 320-1, 320-2, 320-4 in whole or in part. The Internet interface 320-3 uses encryption for the link to the FTS 130 in some embodiments.

The retail interface 320-4 allows for specialized interaction by an agent at the retail location. Agents typically have special training and offer enhanced services over most interfaces 320 and handlers 324. The agent can move money between users and merchants. Also, the agent can pay-in and pay-out money to and from the FTS 130. The retail interface 320-4 allows an agent to act on behalf of the user when manipulating the user's account. For security, the user's password or PIN may be entered by the user during this manipulation. Further, the agent may verify the identity of the user acting on behalf of the user. In one embodiment, a test question is provided by the user that the merchant must answer before any funds are paid-out.

Interaction with the FTS 130 may also be performed over a telephone 140 interfaced to the plain-old telephone system (POTS) 155. The phone interface 320-5 provides voice prompts and recognizes the user's touch-tone or speech recognized input. Enhanced interaction with the phone interface 320-5 could be provided with wireless phones having wireless access protocol (WAP) and/or browser graphical user interfaces (GUIs).

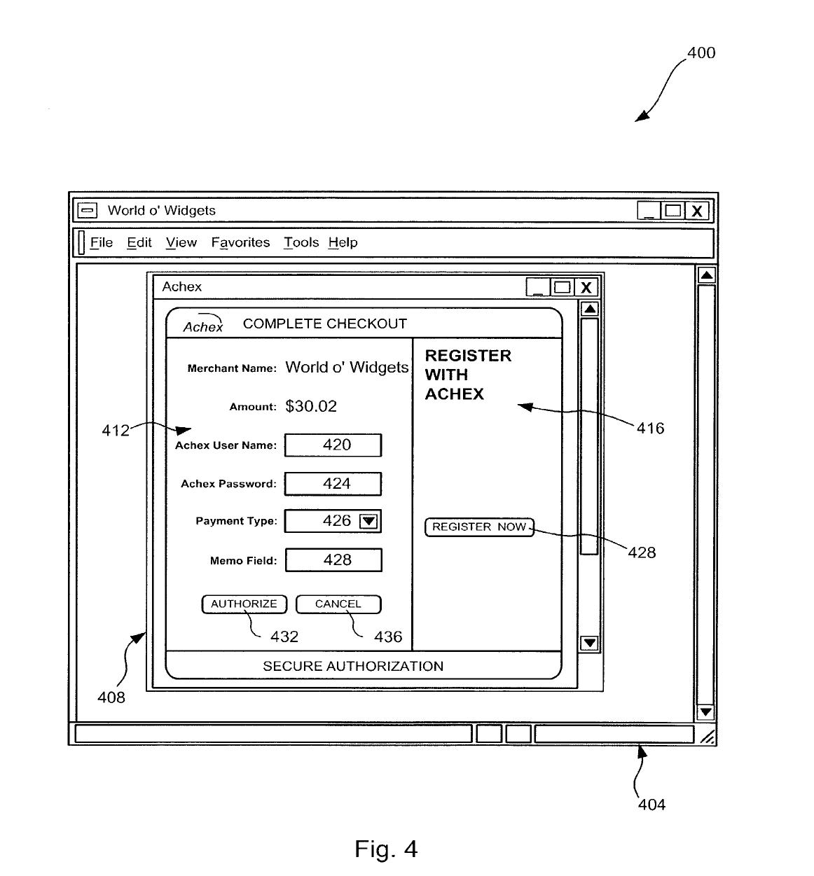

With reference to FIG. 4, a screen shot 400 of an embodiment of a checkout window 408 overlaying a merchant window 404 is shown. The checkout window 408 is called by the merchant web site 220 during the checkout process to solicit authorization from the user and configure the transfer of payment. In this embodiment, the checkout window 408 overlays a merchant window 404. The checkout window has an authorization and authentication portion 412 and a registration portion 416. The registration portion 416 allows new users to add an account to the FTS 130 by clicking on a “register now” button 428 before returning to authorize the transfer.

Information gathered by the merchant system 120 can optionally be passed to the FTS 130 to prepopulate any of the fields in the forms. In some cases, those fields can be modified by the user. Any modifications are optionally passed back to the merchant system 120. In other embodiments, the inconsistencies are noted without correction. Inconsistencies between the merchant and FTS could affect fraud risk for a transaction, which could increase fees to the merchant or prevent completion of a transaction altogether.

The authorization and authentication portion 412 of the checkout window 408 allows authorizing the transfer to the merchant. In this embodiment, the merchant supplies the merchant name and amount for the authorization and authentication portion 412. Some embodiments could use information from the merchant to also populate the user name and memo fields 420, 428. A payment type field 426 allows selecting from a number of accounts configured with the FTS 130 to fund payments for the user. To authorize the transfer, the user enters the user name 420, a FTS password 424, the payment type 426, and an optional memo 428 before clicking the “authorize” button 432. The memo field 428 is maintained in the FTS database 308 and is shown when the transaction is later viewed and may be passed to the user bank 604 for inclusion on the bank statement. In some embodiments, the drop-down payment type menu 426 may appear in a subsequent web page to allow specifying a source for the transfer. If the user wishes to cancel the transfer, the “cancel” button is activated, whereafter the cancellation is reported back to the merchant authorization component 212. Upon successful authentication of the user and authorization of the purchase, respective codes are passed back to the merchant to evidence this success.

The account information of the user and merchant is generally not available to the counterparty in this embodiment. Although the FTS 130 knows the account information for the user and merchant, that information is not passed to the counterparty by the FTS 130. The merchant could be passed demographic information on the user to allow delivery of purchased items, but account information is generally guarded from the counterparty.

The checkout window 408 in this embodiment allows both authentication by login and authorization with the authorize button 432. Other embodiments could separate the authentication and authorization functions into successive screens in the window. For example, the user would first login with user name 420 and password 424. After login, the user would be given transaction details with the ability to authorize the transaction.

In some embodiments, merchants could selectively allow the FTS 130 to perform authentication and/or authorization. For example, a merchant may gather authentication information in the merchant window 404 before the checkout window is activated to seek authorization. Proper messaging between the merchant system 120 and the FTS 130 would allow both parties to know when authentication and authorization has been performed by whichever party.

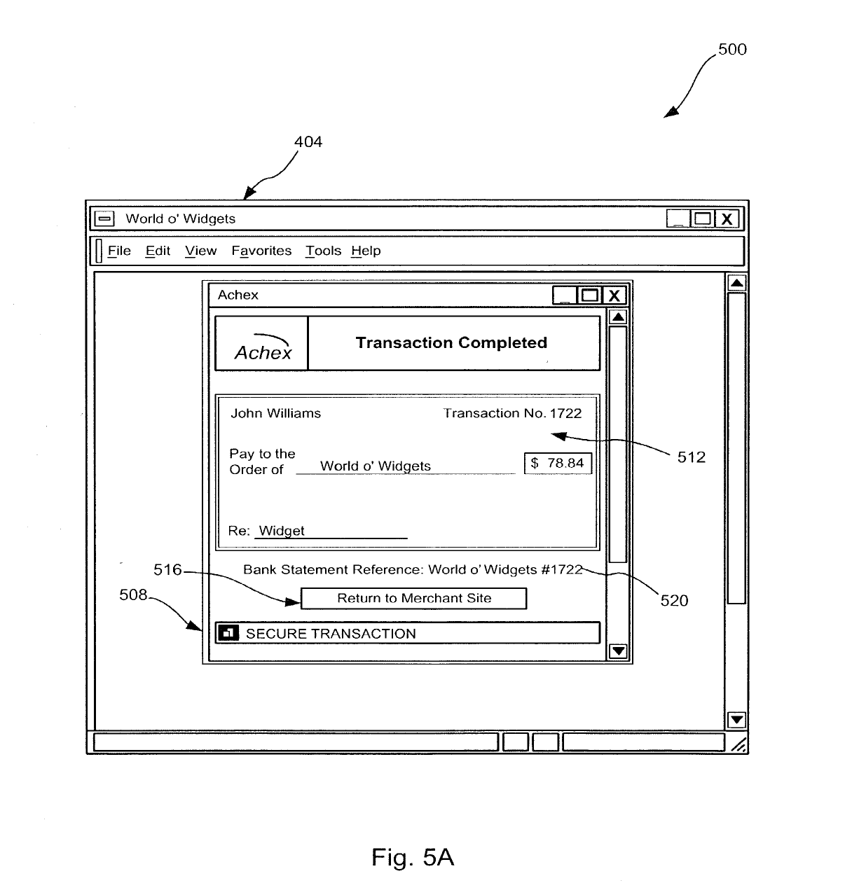

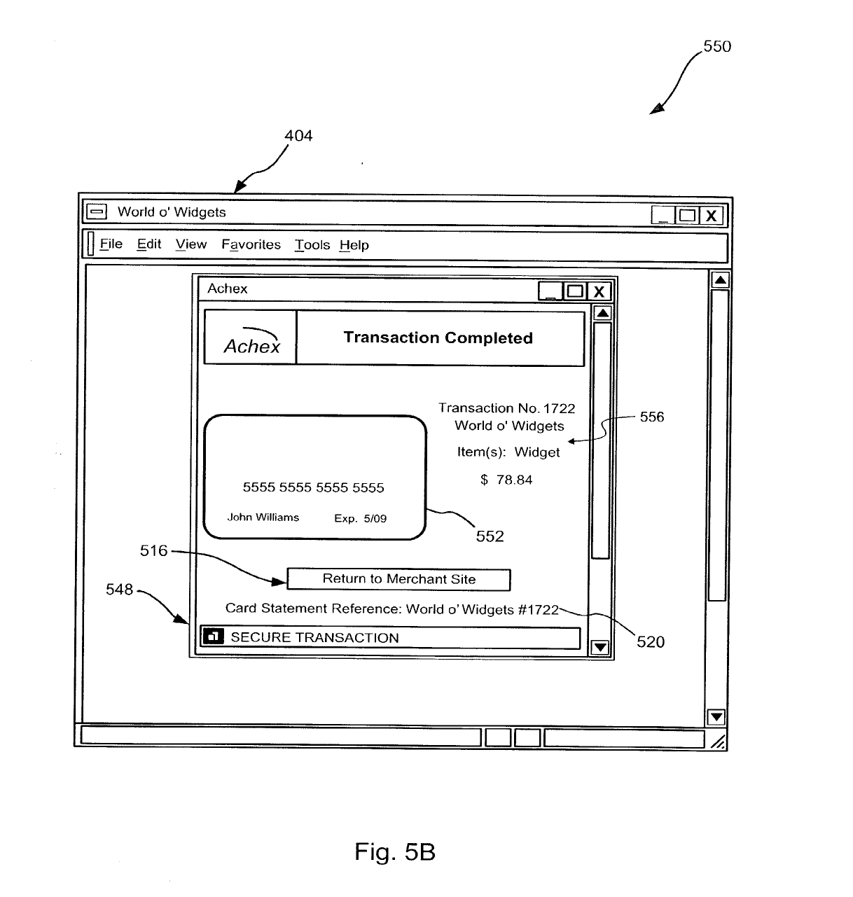

With reference to FIG. 5A, a screen shot 500 of an embodiment of a confirmation window 508 overlying the merchant window 404 is shown. The confirmation window 508 in this embodiment uses a check metaphor to confirm the withdrawal of funds from the user's bank account using the bank handler 324-4. After the user successfully approves the transaction with the checkout window 408, the confirmation window 508 is presented to the user. A check pictogram 512 is presented in the confirmation window that includes the memo field 428 on the “Re:” line, the merchant name, the amount, the user name, and a transaction number in a manner similar to a traditional paper check. Below the check pictogram 512 is a bank statement reference 520, which is passed in a field in the ACH file used to perform the transfer. Some banks can put this bank statement reference 520 on the statements of the user and/or merchant such that the transaction is readily identifiable from the statement.

Once viewing of the confirmation window 508 is complete, the “return to merchant site” button 516 is activated. In this embodiment, activation of that button 516 closes the confirmation window 508 to reveal the underlying merchant window 404. In other embodiments, a script customized for the merchant is activated upon clicking the return button 516. This script could redirect the confirmation window back to the merchant site such that an underlying merchant window 404 is superfluous. In some embodiments, the script could pull up an advertisement or any other task capable of being scripted upon activation of the button 516.

Referring next to FIG. 5B, a screen shot of an embodiment of a card confirmation window 548 overlying the merchant window 404 is shown. In the confirmation window 548, transaction information 556 is shown along with a credit card pictogram 552. The pictogram 552 depicts the charge or debit card chosen to fund the transfer using a familiar plastic card metaphor. A card statement reference 520 is shown in the confirmation window 548 that matches an identifier that will appear on the user's card statement and the merchant's bank statement. Some embodiments could have the merchant's statement depict other information such as an order number, a customer name, a customer number, a digital IOU code, etc.

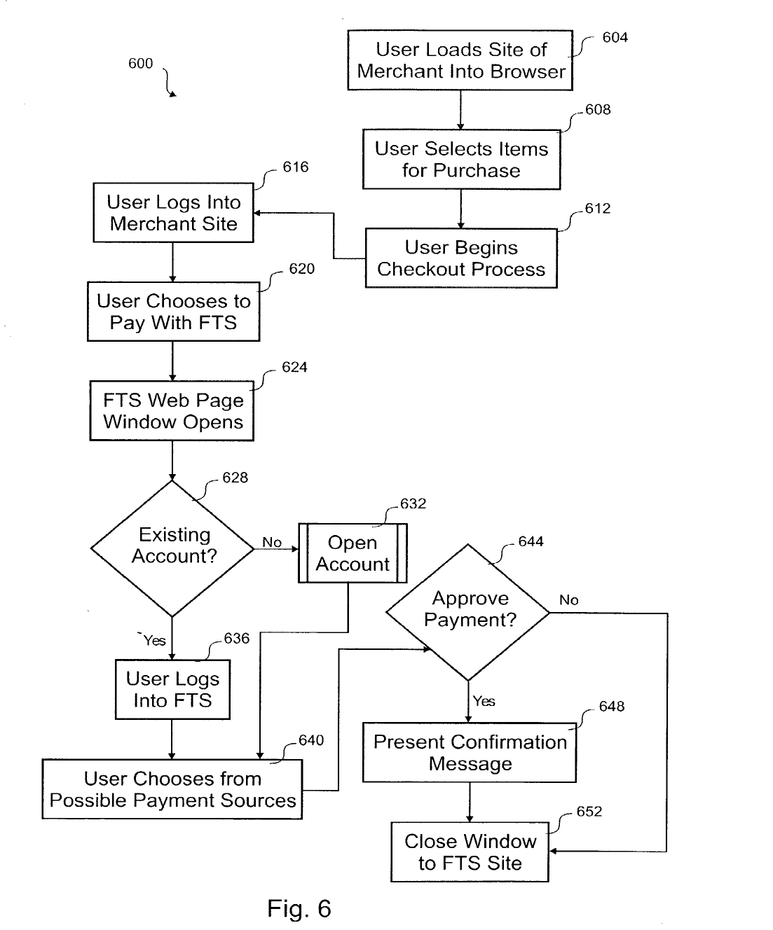

Referring next to FIG. 6, a flow diagram of an embodiment of a process 600 for authorizing a payment from a perspective of a user is shown. This diagram shows the portion of the process 600 that includes choosing an item for purchase from the merchant web site 220 through the authorization of that purchase. Those skilled in the art appreciate that this process is equally applicable to person-to-person payments where selection of merchandise is typically not done, but the authorization process is similar.

The depicted portion of the process 600 begins in step 604 where the user points the web browser 612 to the merchant web site 220 by following a link or otherwise specifying a URL of the merchant web site 220. The merchant web site 220 is browsed to select one or more items for purchase in step 608. In some embodiments, such as with charitable giving, nothing tangible is selected when browsing the site 220, but nonetheless, a transfer of money to the charity is preformed. Once all items are selected for purchase, the checkout process begins step 612. How the merchant organizes the checkout process may vary in various embodiments.

In this embodiment, the user logs into the merchant site in step 616 if this step has not already been completed during the prior browsing of the merchant site 220. This process 600 presumes the user chooses to pay the merchant with a transfer from the FTS 130 in step 620. Some embodiments could have the merchant supply other payment options such as credit card, check, stored value accounts, etc. that could avoid the use of the FTS 130 or could use an alternative FTS. Other embodiments could allow the FTS 130 to accept these forms of payment or a subset of these specified by the merchant. For example, if the merchant accepted credit cards, this would be redundant with the ability of the FTS 130 to accept credit cards. The FTS 130 could prevent paying that merchant with a credit card for this or any other reason. Presumably, the user would pay using a credit card through the merchant site 220, but could use the FTS 130 to pay with promotional points, a gift certificate, cash at a retail location, or a bank account.

In step 624, the checkout window 408 from the FTS web pages 820 is opened to overlay the merchant window 404. A HTML code or script causes the opening of a checkout window 408. HTML codes and scripts are interpreted by the web browser to cause the overlaying checkout window 408 to be opened. The merchant window 404 may display a status message or information to assist the user in the purchase. For example, the merchant window 404 may say “awaiting authorization” or “if the FTS window didn't automatically open click this link.” In step 628, the user either interacts with the authorization or registration portions 412, 416, which is dependent on whether the user is already registered with the FTS 130. Where there is no current registration, a new account is opened in step 632 which may involve interacting with another window that is closed after registration to uncover the checkout window 408. Some embodiments could allow registration from the same checkout window 408 without opening a new window. If an account already exists, processing continues from step 628 to step 636 where the user logs into the FTS 804. Upon successful login, an authentication code is generated by the FTS and passed to the merchant system 120. In this embodiment, a login identifier and password are used to authenticate the user, but other embodiments could use biometric authentication instead of or in addition to user name and password authentication.

Once an account is logged into or otherwise created, user may override a default payment type field 426 to select any payment source in step 640 that is configured for the user. Some embodiments may cull down the possible payment sources to those accepted by the merchant for use through the FTS 130. In step 644, the user has the option of approving the payment. Information on the transaction such as the merchant, total charge, etc. are presented in the checkout window to aid the user with the decision. If the user cancels payment through the FTS 130, a status message may be presented before closing the FTS window to reveal the underlying merchant window 404 of the merchant web site 220 in step 652. Some embodiments allow selecting another payment option from the merchant system 120 after cancellation of payment with FTS 130 is selected.

Where the payment is approved in step 644, a confirmation window 508 is presented in step 648 to confirm the payment. The user can click a button 516 to close the confirmation window 508 and return to the merchant web site 220 in step 652. In some embodiments, the merchant may customize the confirmation window 508 and customize the action taken when the button 516 is pressed. The confirmation window 508 can be printed for a payment receipt. Additionally, the transaction is stored in the FTS database 308 for later retrieval. Status of the redemption and clearing of the digital IOU is also available from the FTS database 308 for later retrieval.

In some embodiments, the user and/or merchant could optionally receive notification messages of events such as issuance of a digital IOU, redemption of some or all of a digital IOU, problems with clearing of a transfer, etc. These messages could be sent by e-mail, WAP, instant messaging, pager, and other messaging mechanisms according to the preferences of the user and/or merchant. In addition to notification information, these messages could include other information, such as account status, promotions, advertisements, etc.

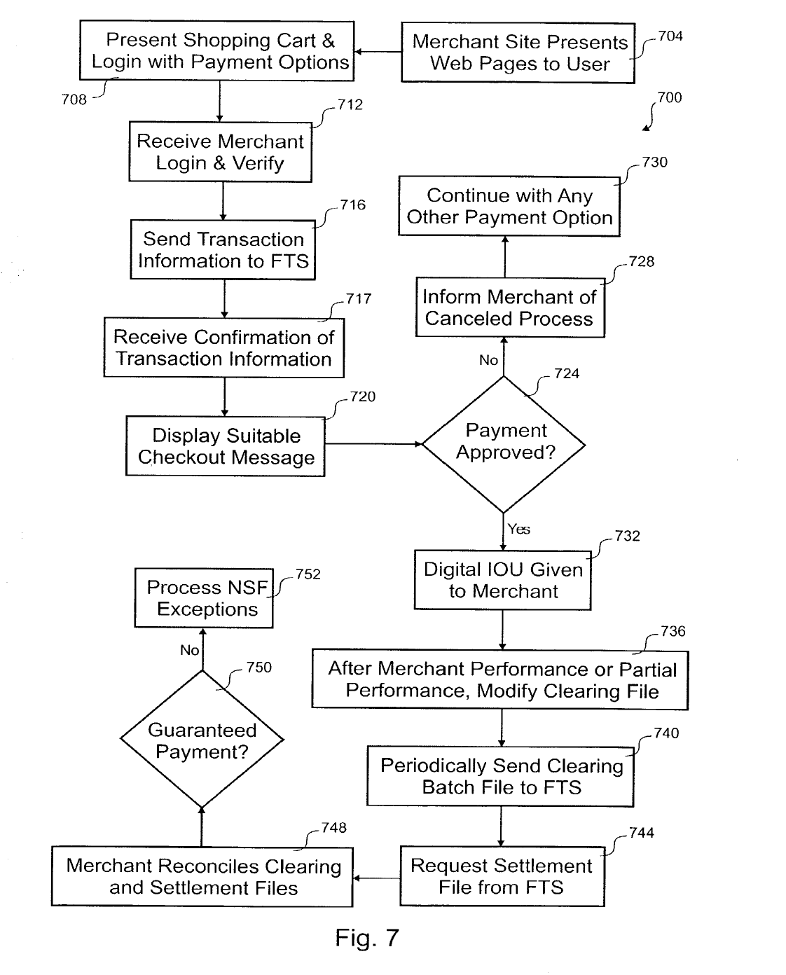

With reference to FIG. 7, a flow diagram of an embodiment of a process 700 for authorizing and clearing the payment from a perspective of the merchant is shown. The depicted portion of the process 700 starts in step 704 where the merchant web site 220 presents web pages to the user to elicit a sale. As the user shops, items are added to the shopping cart of the merchant site 220. Once done shopping, the user initiates the checkout process and the merchant site 220 presents the shopping cart to the user with login name/password request and payment options in step 708. In this embodiment, the login name/password authenticates the user for the merchant alone in step 712.

Other embodiments might present a login that is secured by the FTS 130 such that the merchant site 220 relies upon the FTS 130 for authentication of the user. The FTS 130 would inform the merchant of a successful login and pass an authentication code unique to that user, that merchant and this login session. In this alternative embodiment, the FTS 130 would serve as the repository for confidential information such as credit cards, bank accounts, home addresses, phone numbers, etc. for each user rather than the merchant system 120. Only the information necessary to the transaction is transferred from the FTS 130 to the merchant system 120 such as a user name and delivery address or credit card information where the merchant is handling the credit card without use of the credit card functions of the FTS 130. The user could avoid re-entering their demographic and payment information at every merchant in this embodiment so long as that merchant could interface to the FTS 130 for this information.

Once the user is authenticated as part of the process 700, and the FTS 130 is chosen for payment, the merchant computer 120 opens a secure channel to the FTS authorization component 312 and passes transaction information such as a merchant identifier, an amount, billing and shipping addresses, reoccurring payment periodicity, a digital signature to authenticate the information and merchant, and any other information on the user, merchant and transaction in step 716. The merchant identifier and digital signature allow verifying the identity of the merchant. In this embodiment, a transaction code is generated by the FTS 130 and sent to the merchant system 120 in step 717. The code is unique to the transaction information and can only be generated by the FTS 130. Once the merchant is known, a check of the FTS database 308 retrieves specific information on that merchant for use in displaying the transaction information in a checkout window 408 at step 720. Although not shown in the figure, users without existing accounts can configure one before authorizing payment.

In step 724, the user can choose to authorize payment to the merchant after completing the required fields of the checkout window 408. Where the user activates the “cancel” button 436, processing continues to step 728 where the merchant is informed of the cancellation in step 728. Some embodiments may present the user with a confirmation of their cancellation in a window. If the user closes the FTS window or otherwise aborts the checkout process by not activating the “cancel” button 436, the merchant is notified after expiration of a timer. After cancellation of payment through the FTS 130, the user can return to the merchant window 404 of the merchant web site 220 to select any alternative payment method.

Where the user does authorize payment in step 724, a digital IOU is presented in a secure channel to the merchant in step 732. In this embodiment, the digital IOU includes a code to uniquely identify the transaction to the merchant. The digital IOU could also include a tracking number, such as a purchase order or invoice number, that was previously supplied by the merchant. An authentication code is provided in or separate from the digital IOU for proof of successful authorization of the user.

The merchant can fulfill the order in part or in whole. For example, once a shirt from an order including many items is shipped, authorization for the cost of the shirt and a portion of the shipping can be added to a clearing file in step 736. By authorizing part of the digital IOU, a portion of the payment promised can be redeemed through submission in a first clearing file. Later, remaining portions of the payment can be secured in a second clearing file as the goods and/or services are realized. Each clearing file is sent to the FTS 130 after each redemption of a digital IOU or after a number of redemptions are compiled in a clearing file and sent periodically in a batch mode shown in step 740. The clearing file is specific to the merchant in this embodiment, but can have digital IOU redemptions from any number of users. Some embodiments may automatically send the clearing file once a dollar threshold is met or may automatically send any clearing file according to some periodic schedule.

Once the clearing files are received, the FTS 130 requests funds transfer through the ACH network 105. For a given merchant, authorizations are recorded in the FTS database 308 for digital IOUs referenced in past clearing files. Clearing time can vary for each transaction. To determine the transactions that have cleared, the merchant 120 may request a settlement file with information gathered from the FTS database 308 for all the outstanding transfers for that merchant. To determine which transfers are still pending, an aggregate of the clearing files can be compared with a received settlement file in step 748. The merchant database 208 stores the information from the clearing and settlement files for the pending transactions. Where the merchant does not have a guarantee from the FTS 130 for payment before the transaction is cleared, the non-sufficient funds (NSF) and other errors are handled in step 752.

In some embodiments, the FTS 130 may guarantee some transactions such that payment to the merchant is processed upon acceptance of the digital IOU by the FTS 130. The settlement file in step 744 would immediately show that the transfer cleared as every digital IOU is honored without question. Where the FTS 130 guarantees payment, there is no need for the merchant 120 to handle non-payment. In some cases, the FTS 130 may selectively guarantee some transactions based upon a scoring of the risk of the transfer being unsuccessful. The guarantee status could be recorded in the settlement file for each transaction.

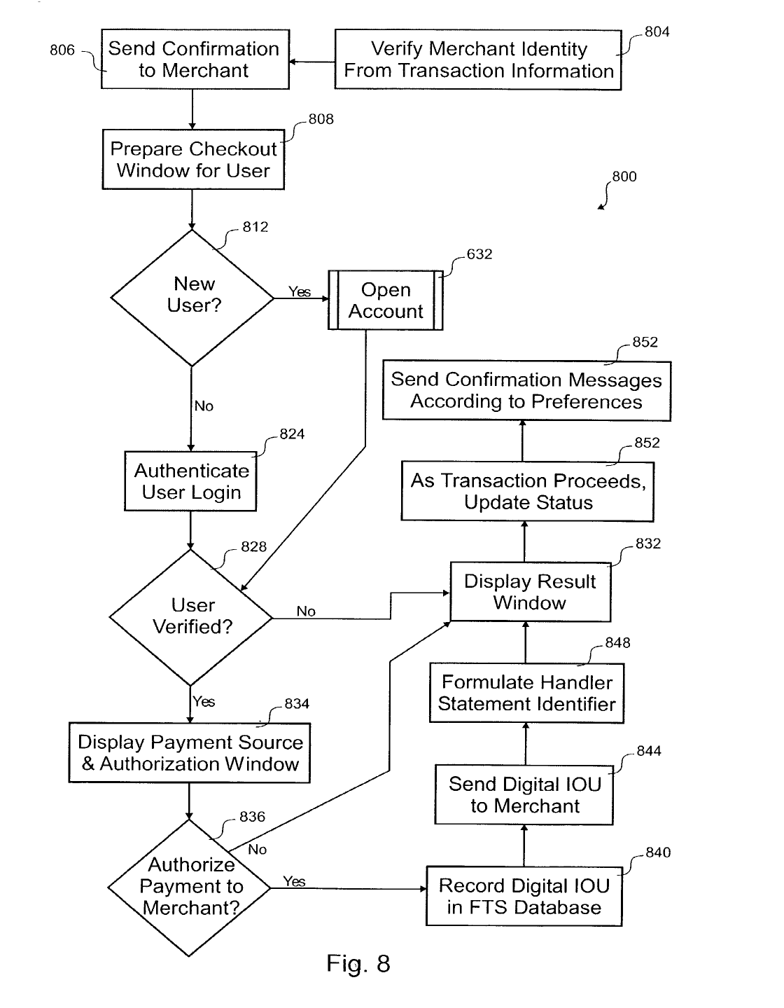

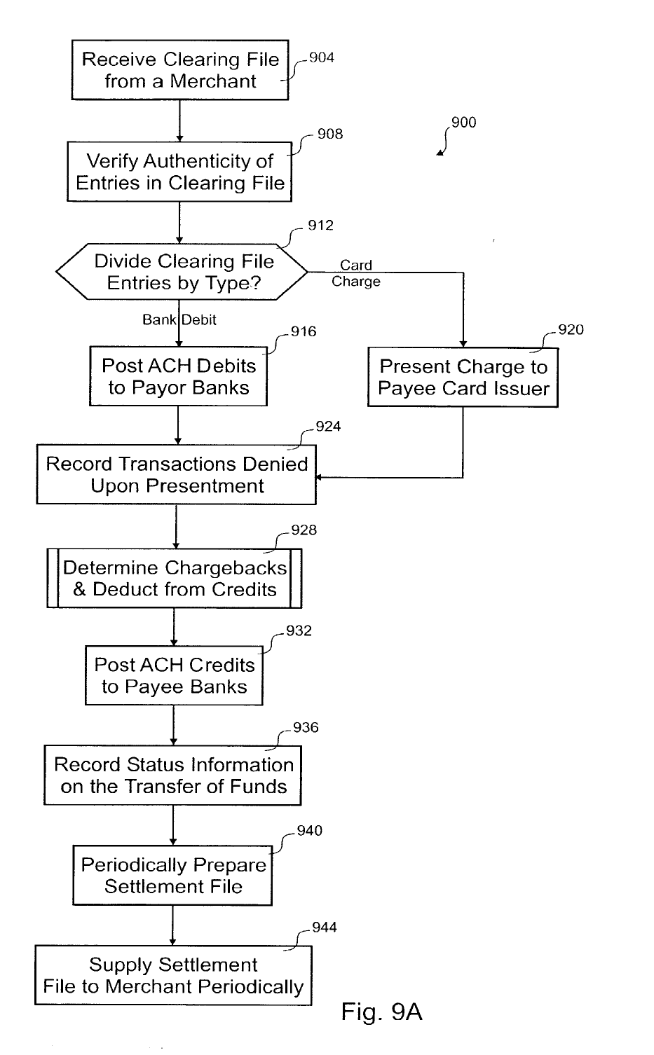

Referring next to FIG. 8, a flow diagram of an embodiment of a process 800 for authorizing the payment is shown from a perspective of the FTS 130. The depicted portion of the process 800 starts in step 804 where the identity of the merchant is authenticated using a digital signature included in the transaction information or other technique. An acknowledgment code could be provided to the merchant after authentication of the merchant. The transaction information is used to personalize authentication and authorization pages that are sequentially presented to the user in steps 808 and 824 in a new window that overlays the merchant window 404. This embodiment presents a login and register page in a window before the window displays a request for authorization page. In other embodiments, the checkout window 408 allows both authentication login and a request for authorization in a single page.

In step 812, new users are separated from existing users. New users open an account in step 632 where none exists. During the account creation process, the FTS 130 authenticates the user-supplied information against databases and any information provided by the merchant before scoring the fraud risk for the new user. If the user already has an account as determined in step 812, the FTS 130 authenticates a user name and password for the user in step 824.

In step 828 it is determined if the user authentication can be verified. Where identity cannot be verified because either the fraud score is unacceptably low or the username and/or password is incorrect, a result window is presented to make the user aware of the problem in step 832. In some cases, the user is allowed to remedy certain failures in verification, which are described in the result window. For example, the password can be re-entered so long as no more than three failures are seen per day. Where the user authentication is satisfactorily verified in step 828, an authentication code indicating that the user successfully proved their identity to the FTS 130 is passed to the merchant system 120.

A further authorization web page is displayed in the current browser window to allow selecting the source of the transfer and to authorize that transfer in step 834. A determination is made in step 836 as to whether the transfer to the merchant was authorized by the user. If the user cancels the transfer, processing continues to step 832 where a results window is presented to allow the user to reconsider their choice or return to the merchant site 220 to select a payment source other than the FTS 130. Where the payment is authorized as determined in step 836, the digital IOU is recorded in the FTS database 308 in step 840 and reported to the merchant in step 844. The digital IOU, among other things, indicates the purchase was authorized by the user.

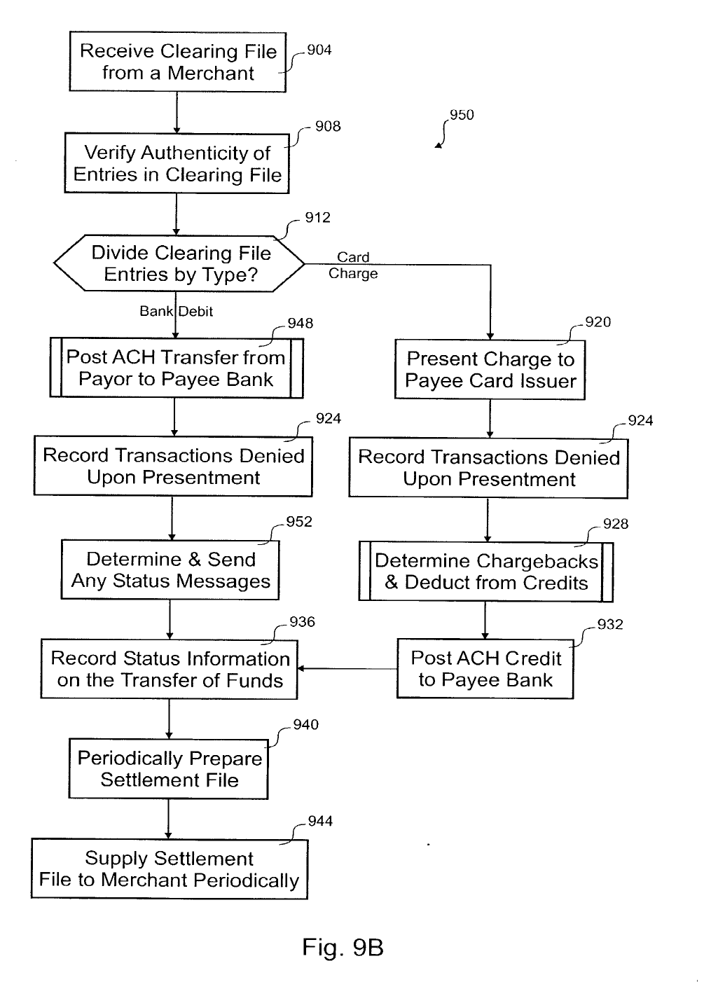

With reference to FIG. 9A, a flow diagram of an embodiment of a process 900 for clearing the payment from the perspective of the FTS 130 is shown. In this embodiment, the payment to the merchant can be made before the payment from the user has cleared. The debits to the user account that do not clear could be deducted from the merchant or could be covered by insurance. Fees associated with the insurance risk could be paid by the merchant to the FTS 130 or a third party insurer.

The depicted portion of the process starts in step 904 where clearing files are received from the various merchants who have authorized digital IOUs that were previously issued by the FTS 130. Each of the clearing files may have one or more entries referenced in the file. The entry corresponds to a particular checkout from a particular user and could include the digital IOU and corresponding digital IOU code, a user identifier, an amount to redeem, a total amount authorized, an authentication code, a designator used by the merchant, a signature over the entry, and other transaction information. In step 908, the entries received are checked against the digital IOUs stored in the FTS database 308 where the amount to redeem reduces the total amount authorized. Any authorizations that exceed the digital IOU are rejected with an error message sent to the merchant either immediately or with the next settlement file.

This embodiment supports a bank handler 324-4 and card handlers 324-2, 324-3. The various debits and credits processed through the handlers 324 could be submitted as they are received or could be submitted in batches according to some criteria. For example, a time period could be used, a numerical threshold of transfers could be used, or an aggregate monetary amount could be used to trigger these transmissions. In step 912, the bank transactions are separated from the card transactions.

Bank transfers are processed in step 916, where this embodiment of the FTS 130 periodically interfaces with the ACH network 105 to submit bank transfers. The FTS 130 posts ACH debit files to the ACH network 105 for the user banks in step 916. Each ACH file contains information to cause the EFT from the user account 140 to the FTS account 160. Included in the file is the statement reference field 520 that can be used on electronic or paper statements associated with the bank. In some embodiments, the ACH files could adhere to the NACHA guidelines.

Transfers funded from a card are processed in step 920. The credit or debit card handler 324-2, 324-3 is used to present the debit to the card issuer 151 of the user. Regardless of whether a bank or card is used to fund the transfer, processing continues to step 924.

Bank and card debits are occasionally refused soon after presentment. For example, a bank account 140 could be closed or a credit card could be beyond the credit limit. In step 924, the debits denied upon presentment are recorded in the FTS database. In this embodiment, the merchant does not receive payment for these transactions. Some embodiments could pay the merchant as an insurer of the transaction. In step 928, the chargebacks, refusals, and non-sufficient funds errors are determined for the entries in the clearing file to the extent possible. Additionally, past clearing file entries that have been now refused could be deducted from the current credits where the payment wasn't insured by the FTS 130.

Each transfer from user to merchant is fulfilled in two separate transactions in this embodiment. An amount of the first transfer for a particular entry in the clearing file may be more than an amount of the second transfer where the difference is accounted for with a fee charged by the FTS 130. This fee may differ based upon, among other things, whether the merchant or the FTS 130 assumes the risk that the first transfer will not clear. In step 932, credits are posted to the ACH network 105 to transfer funds from the FTS account 160 to the merchant account 150. A particular merchant may get a transfer for each entry in the clearing file or may get a single transfer that aggregates payments from a number of entries.

Over time, the ACH network 105 and card issuers 151 report transfers that clear and errors for those that don't. The FTS database 308 is updated to reflect the clearing status and errors in step 936. Any entries that were paid in step 932 also have their status updated in the FTS database 308 in step 936. A settlement file is prepared in step 940 that may include information on all outstanding transactions or just those presented in the clearing file. The settlement file includes information on all authorized, but uncleared, transfers for the requesting merchant. Also, the settlement file may include transfers that have been reopened through a dispute or fraud investigation. That settlement file is supplied to the merchant in step 944. In addition to periodic sending of settlement files, the merchant can request a settlement file at any time or request status on a single transfer.

With reference to FIG. 9B, a flow diagram of another embodiment of a process 950 for clearing the payment is shown where the funds transfer server 130 transfers bank debits directly to the merchant account 150 without using an intermediate FTS account 160. The topology of this embodiment is shown in FIG. 1B above. A transfer may later be disputed, but this embodiment has usually paid the merchant by that point. Disputed user payments that have been previously paid may be deducted from future transfers to the merchant or otherwise recovered from the merchant. The depicted steps of this embodiment vary from the embodiment 900 of FIG. 9A between steps 912 and 940.

Focusing largely on the differences in this embodiment 950, the bank account debits are separated from the card debits in step 912 as before. In the case of a bank account debit, an ACH file is formulated for a transfer from the user account 140 to the merchant account 150. In step 948, that ACH file is posted to the ACH network 105. The ACH file includes a bank statement reference field that the user and merchant banks 104, 106 can optionally include on their account statements respectively issued to the user and merchant. Any transactions that are denied upon presentment are recorded in step 924 along with any explanation for denial. Any later denials or chargebacks are also recorded in the FTS database 308 in step 936. For errors or for status the merchant and/or user has requested, those messages are formulated and sent in step 952. Later denials or chargebacks could generate messages to the merchant and/or user based upon preferences previously specified. Fees due the FTS 130 could be deducted from other payments or billed in other ways for direct transfers between user and merchant.

Stepping back in the process 950 to card funded transfers, processing continues from step 912 to step 920 where a card is used by the user to fund payment to the merchant. In step 920, the redeemed portion of the digital IOU is presented to the user card issuer 151 for authorization and payment. The transactions denied upon presentment are recorded in the FTS database 308 along with any reasons for the denial. Later chargebacks and fraud claims are also recorded. In step 928, any chargebacks or amounts owed the FTS 130 are deducted from payments due a merchant in this embodiment. Fees due the FTS 130 could also be deducted at this point. In step 932, the remaining credit due the merchant is paid through an ACH transfer. There could be a transfer for each redeemed portion of a digital IOU or those transfers could be aggregated. Any further status information for the transfers is recorded in step 936.

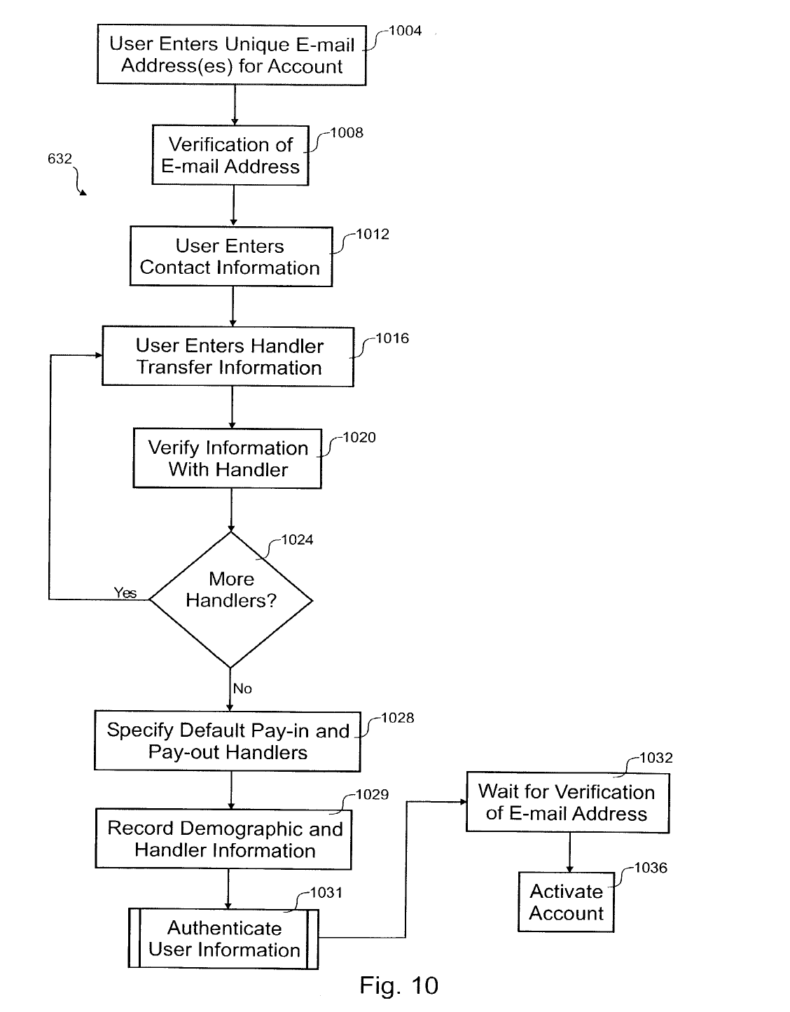

Referring to FIG. 10, a flow diagram of an embodiment of a process 632 for configuring a user with an account for the FTS 130 is shown. This embodiment creates an account for every user. That account could be created to complete the transfer or could be created in advance to the online transaction. The account could be used to purchase items at any number of merchants who accept payment from the FTS 130. The depicted portion of the process 632 begins in step 1004 where the user enters an e-mail address as the unique identifier for the account. The user may want to enter any other e-mail addresses that are aliases of the user and that may be used by counter parties to a transaction. Other embodiments could use any unique identifier for the user instead of an e-mail address.

Once an e-mail address is given to the FTS 130, it is verified. A message is sent to the e-mail address in step 1008. A code embedded an URL is provided in the verification e-mail such that the user can click on the URL to load a page where the code is entered to verify the e-mail address. In this embodiment, the code is a randomly generated set of alphanumeric characters. Other embodiments could use any number of methods to verify the e-mail address.

The user enters contact information into a web page of the merchant web site 220 in step 1012. This contact information could include address, phone number, wireless pager number or address, instant message address, wireless phone address, contact e-mail address, etc. In some cases, the user could be creating an account during a checkout process with a merchant and that merchant could pass any contact information to the FTS 130 to allow prepopulating some fields in the forms. In step 1016, the user enters handler interface information. For example, the user might enter credit card information and/or bank account information. In step 1020, the information is verified with the handler 324 to the extent possible for that handler 324. In step 1024, the process 632 can loop back to step 1016 for entering and verifying additional handlers.

In step 1028, a default input handler 324 and a default output handler 324 can be chosen for transferring money into and out of the system 100 for that user. These two handlers 324 may be different. In some cases, a user may act as a merchant and vice-versa such that any account with the FTS 130 could both send and receive funds. The information entered by the user is stored in the FTS database 308 in step 1029. In some embodiments, the user could be authenticated in step 1031. In step 1032, the FTS 130 waits for verification at least one of the e-mail addresses before activating the account for sending and receiving money with that e-mail address in step 1036.

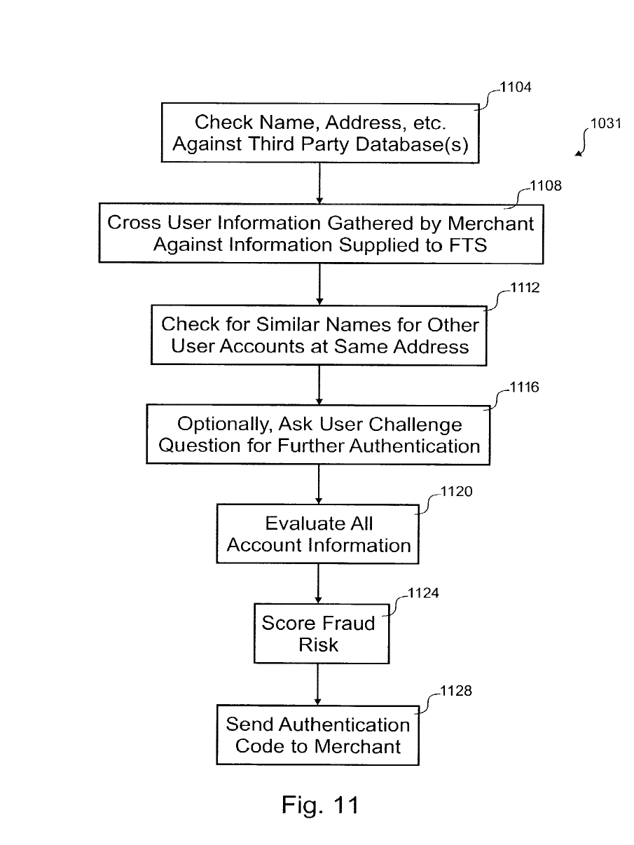

With reference to FIG. 11, a flow diagram of an embodiment of a process 1031 for authenticating user information is shown. Information from users and merchants can potentially be fraudulent or have mistakes. The reliability of the information and the credit worthiness of the FTS accountholder influences the fraud risk score of a user. During the account creation process 632, a name, an address, account numbers and other information is provided to the FTS 130. In step 1104, this supplied information is checked against databases of information maintained by third parties. Information that the merchant previously gathered for the user is provided to the FTS 130. In step 1108, any information provided by the user is checked against information given to the FTS 130.

In step 1112, a check is made for the user to determine if multiple accounts are opened with the FTS 130. Under some circumstances, the user may be asked to reconcile the multitude of accounts. In step 1116, the user could be asked a challenge question, for example, the city of their birth or the maiden name of their mother. In step 1120, the various information gathered in the previous steps is analyzed. In step 1116, the fraud risk is scored. Certain scores that don't satisfy a threshold will result in denial of an account. Other risk scores just affect the cost to the merchant to for the FTS guaranteeing a particular transaction.

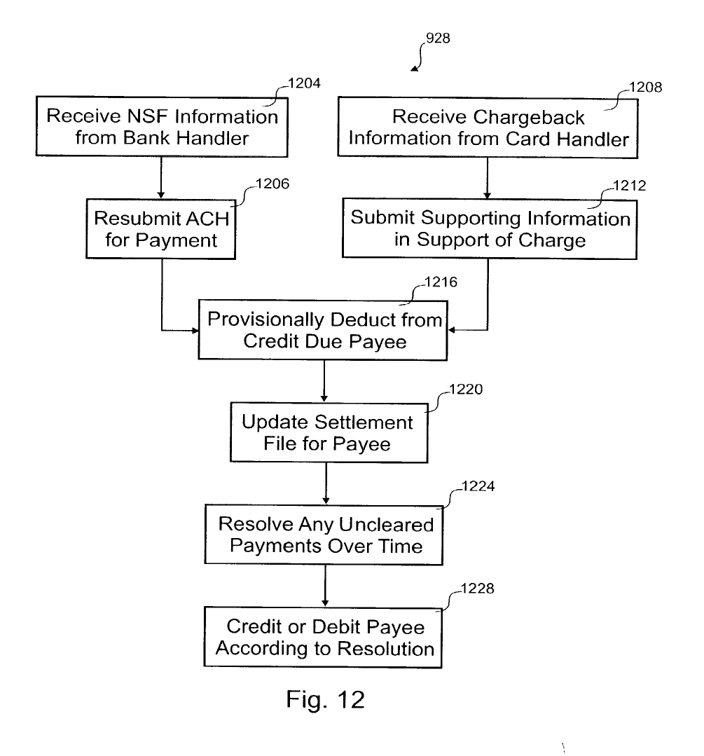

Referring next to FIG. 12, a flow diagram of an embodiment of a process 928 for updating settlement with merchants is shown. This process 928 receives clearing information from both banks and credit cards. Other embodiments could include provide from clearing from other handlers 324. As described above, some transfers fail soon after submission, but others may encounter problems at a later time. The FTS 130 determines which transfers fail and then determines how to resolve those failures. In some embodiments, the FTS 130 absorbs the cost of the failure rather than the merchant.

For transfers originating from a user bank account 140, processing begins in step 1204 where non-sufficient funds and other errors are received from the handler 324-4. These errors can take a week or more to appear after the transfer was originally submitted to the ACH network 105. For bank debits that have only been denied once, they may be resubmitted in step 1206. A message could be sent to the user as notification for the error. Some embodiments may impose a fee on the user for the funding problem.

Credit card payments begin being processed in step 1208, where chargeback information is received from the handler 324. Information supporting the card transaction is submitted in step 1212 to the handler 324. Various chargeback situations may require various support documentation. Regardless of how the transaction was funded, processing continues from steps 1204 and 1212 to step 1216.

In step 1216, credit due the merchant is provisionally reduced by the transfer in question. The transfers that are disputed or fraudulent are repaid by the merchant and not the FTS 130. In step 1220, the settlement file is updated for the merchant. Over time, the challenged transfers are resolved in step 1224. The merchant is responsible for any transfers successfully challenged as shown in step 1228.

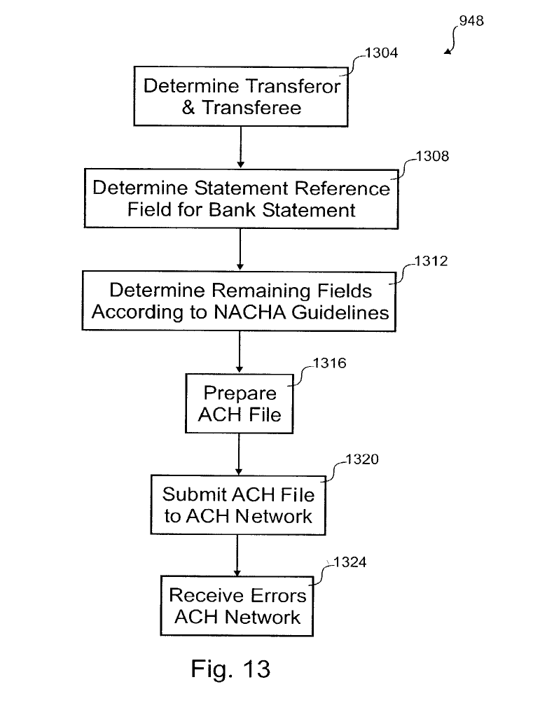

With reference to FIG. 13, a flow diagram of an embodiment of a process 948 for performing an ACH transfer is shown. The depicted portion of the process 948 begins in step 1304 where the parties to the transfer are determined. In this embodiment a user is paying for a purchase from a merchant. In step 1308, the statement reference field 520 is determined. This field 520 is passed to user and merchant banks 104, 106 for possible inclusion on the statement issued for the account. In this embodiment, the transfer is done directly from the user account 140 to the merchant account 150, but other embodiments could use the FTS account 160 in the middle of two transfers.

In step 1312, the remaining fields of the ACH file are determined according to the NACHA guidelines. The ACH file is prepared in step 1316 before submission to the ACH network 105 in step 1320. Any initial errors are received from the ACH network 105 in step 1324 and processed in the ways described above.

It will be apparent to those skilled in the art that various modifications and variations can be made in the method and system of the present invention without departing from the spirit or scope of the invention. Thus, it is intended that the present invention include modifications and variations that are within the scope of the appended claims and their equivalents.

1. A method for transferring funds related to a checkout process for a transaction initiated online between a user and a merchant, the method comprising steps of:
storing information on a plurality of asset accounts associated with the user, wherein each of the plurality of asset accounts comprises a source of funds;
receiving selection of a first account from the plurality of asset accounts as possible choices;
receiving authorization via the interface from the user over a wide area network to pay the merchant from the first account;
providing a digital IOU to the merchant;
receiving a redemption request of the digital IOU;
determining, automatically with a funds transfer server, a second account associated with the merchant; and
initiating, automatically with the funds transfer server in response to the redemption request, an electronic transfer between the first account and the second account that is related to the checkout process for the transaction.

2. The method for transferring funds related to the checkout process for the transaction initiated online between the user and the merchant as recited in claim 1, wherein the initiating step comprises a step of submitting the electronic transfer to an automated clearinghouse (ACH) network.

3. The method for transferring funds related to the checkout process for the transaction initiated online between the user and the merchant as recited in claim 1, wherein an intermediate account is avoided during the electronic transfer.

4. The method for transferring funds related to the checkout process for the transaction initiated online between the user and the merchant as recited in claim 1, further comprising a step of receiving a selection of merchandise from the merchant to purchase with the first account.

5. The method for transferring funds related to the checkout process for the transaction initiated online between the user and the merchant as recited in claim 1, further comprising steps of:
determining notification preferences for at least one of the user and the merchant; and
providing notification to at least one of the user and the merchant of the electronic transfer.

6. The method for transferring funds related to the checkout process for the transaction initiated online between the user and the merchant as recited in claim 1, further comprising steps of:
determining types of accounts acceptable to the merchant as funding sources;
culling the plurality of asset accounts to present only account types acceptable to the merchant; and
presenting the culled plurality of asset accounts to the user.

7. The method for transferring funds related to the checkout process for the transaction initiated online between the user and the merchant as recited in claim 1, wherein a fee is charged to at least one of the user and the merchant for the electronic transfer.

8. The method for transferring funds related to the checkout process for the transaction initiated online between the user and the merchant as recited in claim 1, wherein the electronic transfer includes a statement reference that is printed on a statement for at least one of the user and the merchant.

9. An online-accessible system for transferring funds in a checkout process for a transaction between a user and a merchant, the online-accessible system comprising:
a first interface to a first account associated with the user;
a second interface to a second account associated with the merchant; and
a funds transfer server that:
stores information on a plurality of asset accounts associated with the user, wherein each of the plurality of asset accounts comprises a source of funds;
receives transaction information from the merchant, wherein the transaction information includes a digital signature;
receives selection of the first account from the plurality of asset accounts as possible choices;
receives a request for payment from the merchant, wherein the request for payment comprises a portion that is compared with the digital signature prior to initiation of the electronic transfer; and
initiates the electronic transfer between the first account and the second account in relation to the checkout process.

10. The online-accessible system for transferring funds in the checkout process for the transaction between the user and the merchant as recited in claim 9, wherein the electronic transfer is submitted to an automated clearinghouse (ACH) network for performance.

11. The online-accessible system for transferring funds in the checkout process for the transaction between the user and the merchant as recited in claim 9, wherein the funds transfer server authenticates an identity of the user.

12. The online-accessible system for transferring funds in the checkout process for the transaction between the user and the merchant as recited in claim 9, wherein the funds transfer server receives authorization for the electronic transfer from the user.

13. The online-accessible system for transferring funds in the checkout process for the transaction between the user and the merchant as recited in claim 9, wherein the funds transfer server notifies at least one of the user and the merchant of status according to previously stored notification preferences.

14. A method for transferring funds in an online transaction between a first party and a second party, the method comprising steps of:
storing information on a plurality of asset accounts associated with the first party, wherein each of the plurality of asset accounts comprises a source of funds;
receiving selection of a first account from the plurality of asset accounts as possible choices;
determining, automatically with a funds transfer server, a second account associated with the second party;
receiving the authorization from the first party over a wide area network to pay the second party from the first account;
providing a digital IOU having a digital signature to the second party;
creating a digital signature log of provided digital IOU's;
receiving a redemption request of the digital IOU;
comparing a portion of the digital IOU with the digital signature log;
initiating, if the comparison indicates the digital IOU is authentic, automatically with the funds transfer server, an electronic transfer between the first account and the second account related to the online transaction.

15. The method for transferring funds in the online transaction between the first party and the second party as recited in claim 14, wherein the electronic transfer is related to a checkout process where the first party is purchasing from the second party.

16. The method for transferring funds in the online transaction between the first party and the second party as recited in claim 14, wherein the electronic transfer avoids any intermediate accounts not part of an automated clearinghouse.

17. The online-accessible system for transferring funds in the checkout process for the transaction between the user and the merchant as recited in claim 9, wherein the funds transfer server:
determines types of accounts acceptable to the merchant as funding sources;
culls the plurality of asset accounts to present only account types acceptable to the merchant; and
presents the culled plurality of asset accounts to the user.

18. The method for transferring funds in the online transaction between the first party and the second party as recited in claim 14, further comprising steps of:
determining types of accounts acceptable to the second party as funding sources;
culling the plurality of asset accounts to present only account types acceptable to the second party; and
presenting the culled plurality of asset accounts to the first party.

19. The method for transferring funds related to the checkout process for the transaction initiated online between the user and the merchant as recited in claim 1, wherein initiating the electronic transfer between the first account and the second account comprises:
initiating a first electronic transfer between the first account and an account associated with the funds transfer server; and
initiating a second electronic transfer between the account associated with the funds transfer server and the second account, wherein the account associated with the funds transfer server is not under control of the user or the merchant.

20. The method for transferring funds related to the checkout process for the transaction initiated online between the user and the merchant as recited in claim 1, wherein the information from the user modifying at least one of the pre-populated fields is transmitted to the merchant.

21. The method for transferring funds related to the checkout process for the transaction initiated online between the user and the merchant as recited in claim 1, wherein the information from the user modifying at least one of the pre-populated fields affects a fraud risk analysis of the transaction.

22. The method for transferring funds related to the checkout process for the transaction initiated online between the user and the merchant as recited in claim 21, wherein a result of the fraud risk analysis is that fees required from the merchant are increased.

23. The method for transferring funds related to the checkout process for the transaction initiated online between the user and the merchant as recited in claim 21, wherein a result of the fraud risk analysis is that the transaction is canceled.

24. A method for transferring funds in an online transaction between a first party and a second party, the method comprising steps of:
receiving, at a funds transfer system, selection of a private payment option from the first party, the private payment option comprising indication of a choice for private transfer of financial information from the user to the funds transfer system;
establishing a secure connection from the funds transfer system to the first party, wherein the secure connection is configured to prevent access by the second party during transfer of the financial information over the secure connection;
receiving user account information from the first party with the funds transfer system via the secure connection, the user account information comprising information regarding a first account;
determining, automatically with the funds transfer system, a second account associated with the second party;
transmitting, via the secure connection, a validation request to the first party;
receiving, via the secure connection, validation information from the first party in response to the validation request;
validating the received validation information with the funds transfer system; and
initiating, if the step of validating the received validation information is successful, automatically with the funds transfer system, an electronic transfer between the first account and the second account related to the online transaction.
